(19) United States
(12) Patent Application Publication
(10) Pub. No.: US 2023/0361709 A1
(43) Pub. Date: Nov. 9, 2023

(54) ESTIMATION DEVICE FOR ESTIMATING DRIVE STATE OF ELECTRIC MOTOR DISPOSED IN MACHINE TOOL

(71) Applicant: FANUC CORPORATION, Yamanashi (JP)

(72) Inventors: Yohei KAMIYA, Yamanashi (JP); Kazunori IIJIMA, Yamanashi (JP)

(21) Appl. No.: 18/245,719

(22) PCT Filed: Dec. 8, 2021
(86) PCT No.: PCT/JP2021/045189

§ 371 Date: Mar. 17, 2023

(30) Foreign Application Priority Data
Dec. 15, 2020 (JP) 2020-207785

(51) Int. Cl. H02P 23/14; G05B 19/4069

(52) U.S. Cl. CPC H02P 23/14; G05B 19/4069; G05B 2219/33286

(57) ABSTRACT

This estimation device comprises a calculation unit that calculates variables indicating the drive state of an electric motor of a machine tool on the basis of a simulation program. The simulation program is a program in which a first auxiliary variable relating to a load factor for estimating the drive state of the electric motor is added to a command statement of a machining program for driving the machine tool. The calculation unit calculates changes in the speed of the electric motor over time on the basis of output characteristics of the electric motor, inertia related to driving of the electric motor, and the first auxiliary variable.

### TECHNICAL FIELD

The present invention relates to an estimation device for estimating a drive state of an electric motor disposed in a machine tool.

### BACKGROUND ART

A machine tool can perform machining while changing a relative position of a tool with respect to a workpiece. The machine tool is provided with an electric motor for rotating the tool and an electric motor for moving the workpiece or the tool. An operator who operates the machine tool generates a machining program in order to determine a workpiece machining method. In the machining program, a target position, a speed, and the like when the workpiece or the tool is moved is described. The electric motor of the machine tool is driven in accordance with the machining program, but in some cases, a drive state of the electric motor such as an angular acceleration is not known unless the machine tool is actually driven.

Therefore, when machining is actually performed by the machine tool, the machining time may be longer than a desired time, or a torque required for the electric motor may exceed an allowable torque and machining may be impossible. Before machining is actually performed by the machine tool, it is preferable to perform a simulation where the drive state of the electric motor is simulated.

In order to estimate the drive state of the electric motor when the electric motor is driven, a known simulation device estimates a rotational position and a rotation speed of the electric motor in accordance with an operation command input to the electric motor (e.g., see JP 2006-340480 A and JP 2012-222890 A).

### CITATION LIST

### Patent Literature

Patent Document 1: JP 2006-340480 A
Patent Document 2: JP 2012-222890 A

### SUMMARY OF INVENTION

### Technical Problem

In the machining program of the machine tool, a command statement for driving the machine tool is described. For example, in the machining program, a command statement called a G code or an M code is described for each line. In the command statement of the machining program are described a command for starting rotation of a spindle axis holding a tool, a command for a target position and a movement speed for moving the spindle axis, a command for a target position and a movement speed for moving a table holding a workpiece, and the like. However, there is a problem in that it is difficult to accurately estimate the drive state of the electric motor by using only these pieces of information.

For example, since an angular acceleration when the rotation speed of the electric motor increases is unknown, a change over time in the rotation speed is not known. Therefore, it is difficult to estimate the time when the electric motor is accelerated. It is also difficult to predict the productivity of the machine tool because the time (cycle time) during which machining is performed by the machine tool is not known.

Moreover, when the drive state of the electric motor can be estimated, the temperature of the electric motor can be estimated by the simulation device on the basis of the drive state of the electric motor. In particular, it is possible to estimate a change over time in the temperature of the electric motor when the electric motor is driven. For example, a value of current supplied to the electric motor can be calculated on the basis of a load factor of the electric motor, and a heat generation amount due to copper loss or iron loss can be calculated on the basis of the value of current flowing through the electric motor. When the temperature of the electric motor can be estimated, for example, it is possible to determine whether the electric motor is driven within an appropriate temperature range. However, there is a problem that it is difficult to estimate the temperature of the electric motor because the drive state of the electric motor is not known.

### Solution to Problem

A first estimation device of the present disclosure estimates a drive state of an electric motor disposed in a machine tool. The estimation device includes a calculation unit configured to calculate a variable indicating the drive state of the electric motor, in accordance with a simulation program created in advance. In the electric motor, time until a target rotation speed is reached when a rotational speed of the electric motor is changed is not determined. The simulation program includes a command statement in which a first auxiliary variable related to a load factor for changing the rotation speed of the electric motor is added to a command statement of a machining program for driving the electric motor when a workpiece is machined. The calculation unit calculates a change over time in the rotation speed of the electric motor on the basis of an output characteristic of the electric motor, a predetermined inertia related to driving of the electric motor, and the first auxiliary variable.

A second estimation device of the present disclosure estimates a drive state of an electric motor disposed in a machine tool. The estimation device includes a calculation unit configured to calculate a variable indicating the drive state of the electric motor, in accordance with a simulation program created in advance. In the electric motor, time until a target rotation speed is reached when a rotational speed of the electric motor is changed is determined. The simulation program includes a command statement in which an auxiliary variable related to a load factor for machining a workpiece is added to a command statement of a machining program for driving the electric motor when the workpiece is machined. The calculation unit calculates a change over time in the load factor of the electric motor on the basis of the time until the rotation speed of the electric motor reaches the target rotation speed, an output characteristic of the electric motor, a predetermined inertia related to driving of the electric motor, and the auxiliary variable.

### Advantageous Effect of the Invention

According to an aspect of the present disclosure, it is possible to provide an estimation device for estimating a drive state of an electric motor by using a simple simulation program.

### BRIEF DESCRIPTION OF DRAWINGS

FIG. 1 is a block diagram of a machine tool of an embodiment.

FIG. 2 is a block diagram of an estimation device for estimating a drive state of an electric motor in an embodiment.

FIG. 3 is an example of a machining program for a machine tool.

FIG. 4 is a first simulation program for carrying out first control in an embodiment.

FIG. 5 is a graph of output with respect to a rotation speed at a load factor of 100% of a spindle motor.

FIG. 6 is a time chart of a drive state of a spindle motor estimated by the first control.

FIG. 7 is a second simulation program for carrying out second control in an embodiment.

FIG. 8 is a graph of output with respect to a rotation speed at a load factor of 100% of a feed axis motor.

FIG. 9 is a time chart of a drive state of the feed axis motor estimated by the second control.

FIG. 10 is a schematic cross-sectional view illustrating a movement path of a tool when a female screw is formed by using a tap.

FIG. 11 is a third simulation program for machining for forming a female screw in a workpiece.

FIG. 12 is a time chart showing a drive state of a Z-axis feed axis motor when the spindle motor is driven following the operation of the Z-axis feed axis motor.

FIG. 13 is a time chart showing the drive state of the spindle motor when the spindle motor is driven following the operation of the Z-axis feed axis motor.

FIG. 14 is a time chart showing the drive state of the spindle motor when the Z-axis feed axis motor is driven following the operation of the spindle motor.

FIG. 15 is a time chart showing the drive state of the Z-axis feed axis motor when the Z-axis feed axis motor is driven following the operation of the spindle motor.

### DESCRIPTION OF EMBODIMENTS

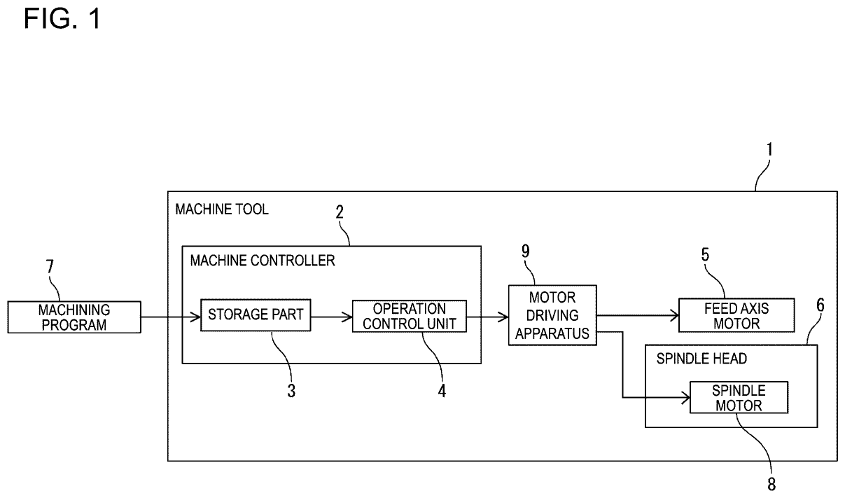

An estimation device for estimating a drive state of an electric motor in an embodiment is described with reference to FIGS. 1 to 15. In the present embodiment, the electric motor is disposed in a machine tool.

FIG. 1 is a block diagram of a machine tool of the present embodiment. A machine tool 1 machines a workpiece while changing a relative position of a tool with respect to the workpiece. The machine tool 1 has feed axes for changing the position of at least one of the workpiece and the tool. The feed axes of the machine tool of the present embodiment are composed of three linear motion axes (X-axis, Y-axis, and Z-axis) orthogonal to each other. The machine tool 1 of the present embodiment is formed such that a table for fixing the workpiece is moved in the direction of the X-axis and the direction of the Y-axis, and a spindle axis for holding the tool is moved in the direction of the Z-axis. The feed axes of the machine tool 1 are not limited to this embodiment, and may be composed of arbitrary linear motion axes or rotary feed axes.

The machine tool 1 includes a moving device that moves at least one of the workpiece and the tool along the feed axes. The moving device includes feed axis motors 5 disposed corresponding to the respective feed axes. The machine tool 1 of the present embodiment includes the feed axis motor 5 that moves the table in the direction of the X-axis, the feed axis motor 5 that moves the table in the direction of the Y-axis, and the feed axis motor 5 that moves a spindle head 6 in the direction of the Z-axis. In the present embodiment, the table or the spindle head 6 corresponds to an object to be driven by the feed axis motor 5. The machine tool 1 includes the spindle head 6 that rotates the tool while holding the tool. The spindle head 6 includes a spindle axis that supports the tool and a spindle motor 8 that rotates the spindle axis.

The machine tool 1 includes a machine controller 2 that controls the feed axis motors 5 and the spindle motor 8. The machine controller 2 includes an arithmetic processing device (computer) including a central processing unit (CPU) as a processor. The arithmetic processing device includes a random access memory (RAM), a read only memory (ROM), and the like, which are mutually connected to the CPU via a bus.

The machine tool 1 of the present embodiment is numerically controlled. A machining program 7 for driving the machine tool 1 is generated in advance by an operator who operates the machine tool 1 or an operator who performs a simulation. The machine controller 2 includes a storage part 3 that stores the machining program 7, and an operation control unit 4 that generates an operation command for the electric motor in accordance with the machining program 7. The machine tool 1 includes a motor driving apparatus 9 including an electric circuit that supplies electricity to the feed axis motors 5 and the spindle motor 8 in accordance with the operation command generated in the machine controller 2. The motor driving apparatus 9 drives the feed axis motors 5 and the spindle motor 8 by supplying electricity thereto. The storage part 3 can be formed of a non-transitory storage medium that can store information. For example, the storage part 3 is formed of a storage medium such as a nonvolatile memory. The operation control unit 4 corresponds to a processor of the arithmetic processing device.

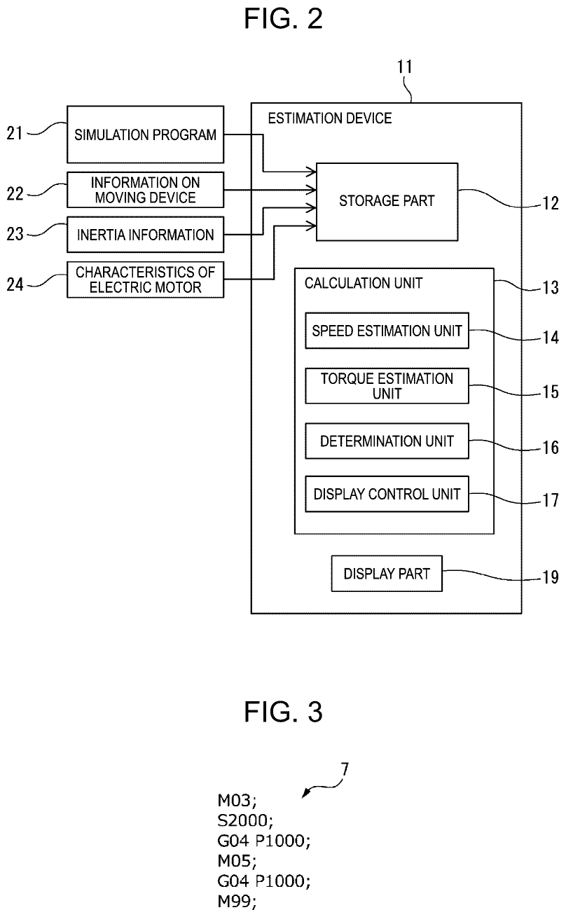

FIG. 2 is a block diagram of an estimation device of the present embodiment. An estimation device 11 estimates a drive state of the electric motor disposed in the machine tool 1. The estimation device 11 of the present embodiment estimates the drive state of the spindle motor 8 and the drive states of the feed axis motors 5. The estimation device 11 of the present embodiment includes an arithmetic processing device (computer) including a CPU as a processor. The estimation device 11 includes a storage part 12 that stores information for estimating the drive state of the electric motor. The storage part 12 can be formed of a non-transitory storage medium that can store information. The storage part 12 may be formed of a storage medium that can store information, such as a volatile memory, a nonvolatile memory, a magnetic storage medium, or an optical storage medium.

The estimation device 11 receives a simulation program 21, which is a program for estimating the drive state of the electric motor. The simulation program 21 is created in advance by the operator who performs a simulation. The moving device includes a reduction gear connected to the electric motor and a drive mechanism for driving a member such as a table. The drive mechanism includes, for example, a ball screw mechanism for moving a table of the machine tool. The estimation device 11 receives information 22 on the moving device. The information 22 on the moving device includes, for example, information such as a gear ratio of the reduction gear and a pitch of a ball screw.

The estimation device 11 also receives inertia information 23. An inertia (moment of inertia) related to driving of the electric motor includes an inertia of a member driven by the electric motor. The inertia related to the driving of the electric motor includes an inertia of a load applied to the electric motor. For example, the inertia includes an inertia of a rotor of the electric motor, an inertia of a reduction gear connected to the feed axis motor 5, an inertia of the spindle axis connected to the spindle motor 8, and the like. The inertia can be calculated in advance by the operator who performs a simulation. The estimation device 11 also receives output characteristics 24 of the electric motor. The simulation program 21, the information 22 on the moving device, the inertia information 23, and the output characteristics 24 of the electric motor are stored in the storage part 12.

The estimation device 11 includes a calculation unit 13 that calculates variables indicating the drive state of the electric motor, in accordance with the simulation program 21. The variables indicating the drive state of the electric motor include a rotation speed of the electric motor, an angular acceleration of the electric motor, a load factor of the electric motor, a rotational position of the electric motor, and the like. The calculation unit 13 includes a speed estimation unit 14 that calculates a change over time in the rotation speed of the electric motor. The calculation unit 13 includes a torque estimation unit 15 that estimates a change over time in the load factor of the electric motor.

The calculation unit 13 includes a determination unit 16 that determines the variables estimated by the calculation unit 13. The calculation unit 13 includes a display control unit 17 that generates a command for displaying a determination result of the determination unit 16 on a display part 19.

The calculation unit 13 corresponds to a processor of the arithmetic processing device that is driven in accordance with a predetermined rule. The calculation unit 13 of the present embodiment corresponds to a processor that is driven in accordance with the simulation program 21. In particular, each of the speed estimation unit 14, the torque estimation unit 15, the determination unit 16, and the display control unit 17 corresponds to a processor of the arithmetic processing device. The processor is driven in accordance with the simulation program 21 and serves as each unit.

The estimation device 11 includes the display part 19 that displays information on the estimation of the drive state of the electric motor. The display part 19 is formed of, for example, a display panel such as a liquid crystal display panel. The display part 19 displays arbitrary information in accordance with a command from the display control unit 17.

The estimation device 11 of the present embodiment estimates variables indicating the drive state of the electric motor in accordance with the simulation program 21 obtained by modifying the machining program 7 for driving the machine tool 1. In the simulation program 21 of the present embodiment, an auxiliary variable for estimating the drive state of the electric motor is added to a command statement in the machining program 7.

The calculation unit 13 of the estimation device 11 of the present embodiment predicts a change in the drive state of the electric motor in time series on the basis of the command statement including the auxiliary variable described in the simulation program 21, the output characteristics of the electric motor, and the inertia related to the driving of the electric motor. The inertia related to the driving of the electric motor includes the inertia of the rotor or the like and the inertia of the load of the electric motor. In particular, the calculation unit 13 calculates at least one of a change over time in the rotation speed of the electric motor and a change over time in the load factor of the electric motor. That is, the calculation unit 13 calculates at least one of the rotation speed of the electric motor and the load factor of the electric motor in time series. The estimation device 11 also estimates a time length during which the machine tool 1 performs a task.

In the first control of the estimation device 11 of the present embodiment, the drive state of the spindle motor 8 is estimated. A time constant for changing the rotation speed of the spindle axis is not specified for the spindle motor 8. The time constant is a length of time until a target rotation speed is reached from one rotation speed. The time constant is a variable corresponding to the angular acceleration of the electric motor. In the control of the present embodiment, the drive state of the spindle motor 8 is estimated in accordance with a simulation program in which an auxiliary variable indicating the load factor of the electric motor is added to the command statement of the machining program.

FIG. 3 illustrates an example of the machining program corresponding to the simulation program in the first control in the present embodiment. In the machining program for the machine tool, a command statement for operating the spindle motor and the feed axis motor is described. The machining program is composed of command statements called codes such as a G code, an M code, and an S code. In the machining program, a command statement is described for each line. The line-by-line command statement is referred to as a block. A variable included in the command statement is referred to as a word.

FIG. 3 shows command statements for rotating and stopping the spindle motor 8. In the machining program 7, a command statement of M03 in the first line is an M code indicating a command for rotating the spindle axis in the forward direction. A command statement of S2000 in the second line is an S code indicating a target rotation speed of the spindle axis. The command statements in the first line and the second line indicate that the spindle axis is rotated in the forward direction until the rotation speed of the electric motor reaches 2000 rpm.

A command statement of G04 in the third line is a G code indicating a dwell function. The command statement of G04 indicates a command for stopping the execution of the machining program during a period in which the machine tool is operating. A variable P1000 indicates a command for stopping the execution of the machining program for 1000 msec. A command statement of M05 in the next line indicates a command for stopping the spindle axis. A command statement of G04 in the next line stops the execution of the machining program for 1000 msec. A command statement of M99 in the last line is an M code indicating the end of a subprogram. In this way, in the machining program 7, command statements are formed by codes and variables (arguments) related to the codes.

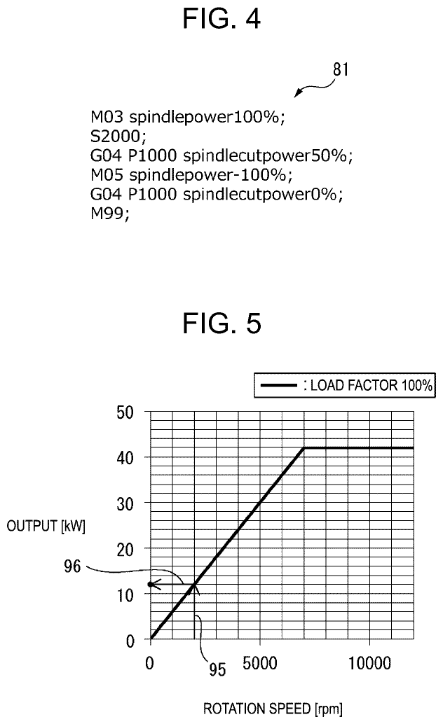

FIG. 4 shows a first simulation program in the first control of the present embodiment. A first simulation program 81 is generated corresponding to the machining program 7 shown in FIG. 3. In the simulation program of the present embodiment, an auxiliary variable indicating a load factor of the electric motor is added to a command statement of a machining program for driving the machine tool. The load factor of the electric motor is the ratio of an output torque to a rated torque.

In the first simulation program 81, a first auxiliary variable (spindlepower) for accelerating or decelerating the spindle motor 8 is described in a command statement of M03 in the first line and a command statement of M05 in the fourth line. The first auxiliary variable is a variable related to a load factor for changing the rotation speed of the electric motor. Each first auxiliary variable is indicated by “spindlepower100%” or “spindlepower-100%”. For example, in the command statement of M03 in the first line is described a command for accelerating the spindle motor 8 at a load factor of 100% on the basis of the first auxiliary variable added to the command statement of the machining program 7.

In a command statement of G04 in the third line and a command statement of G04 in the fifth line, a second auxiliary variable (spindlecutpower) related to the load factor for machining a workpiece is described. In the present embodiment, the rotation speed of the electric motor is constant during the period in which the workpiece is machined. The second auxiliary variable indicates a load factor corresponding to a cutting torque of the workpiece. As the second auxiliary variable, “spindlecutpower50%” indicating the load factor of the spindle motor 8 during cutting is described in the command statement of G04 in the third line. That is, “spindlecutpower50%” indicates that the workpiece is cut when the load factor of the spindle motor 8 is 50%. In the command statement of G04 in the fifth line, “spindlecutpower0%” is described because the cutting is completed. Such a load factor of the electric motor can be determined in advance by the operator who performs a simulation. The simulation program 81 is formed by adding the first auxiliary variable and the second auxiliary variable to the command statements of the machining program 7.

FIG. 5 is a graph showing output characteristics of the spindle motor. The output characteristics of the electric motor indicate the relationship between output and the rotation speed of the electric motor when the electric motor is driven at a load factor of 100%. A horizontal axis indicates the rotation speed of the spindle motor 8, and a vertical axis indicates the output of the spindle motor 8. The characteristics are shown in which the output is proportional to the rotation speed until the rotation speed reaches about 7000 rpm.

Referring to FIG. 2, in the first control, the speed estimation unit 14 of the calculation unit 13 calculates the angular acceleration of the spindle motor 8 on the basis of the first auxiliary variable. The speed estimation unit 14 estimates a change over time in the rotation speed of the spindle motor 8. In other words, the speed estimation unit 14 calculates a change in the rotation speed of the spindle motor 8 in time series. Then, the speed estimation unit 14 estimates the time until the rotation speed of the spindle motor 8 reaches the target rotation speed, on the basis of a change over time in the rotation speed.

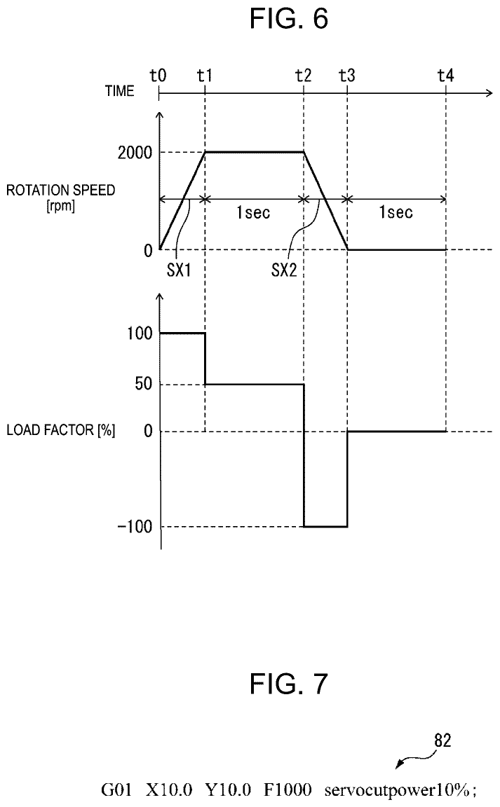

FIG. 6 illustrates a time chart of the drive state of the spindle motor estimated by the first control of the present embodiment. Referring to FIGS. 4 and 6, from the time t0 to the time t1, the rotation speed of the spindle motor 8 increases in accordance with the command statements of M03 and S2000. The rotation speed is accelerated to 2000 rpm in accordance with the command statement of S2000. The load factor for acceleration of the spindle axis at this time is set to 100% by “spindlepower100%”, which is the first auxiliary variable added to the command statement of M03.

During the period from the time t1 to the time t2, the rotation speed is maintained for one second in accordance with the command statement of G04 in the third line. The load factor of the spindle motor for cutting during the period from the time t1 to the time t2 is set to 50% by the second auxiliary variable. From the time t2 to the time t3, the rotation speed is decelerated at a load factor of −100% according to the first auxiliary variable of the command statement of M05. After the time t3, the load factor for cutting is maintained at 0% for one second according to the second auxiliary variable of the command statement of G04 in the fifth line.

FIG. 5 illustrates a graph of output characteristics when the load factor is 100%. Until the rotation speed of the spindle motor 8 reaches about 7000 rpm, the output increases in proportion to the rotation speed. Since the output of the electric motor is calculated by multiplying the rotation speed by a torque, a torque output by the electric motor is constant until the rotation speed reaches 7000 rpm.

The time length from the time t1 to the time t2 and the time length from the time t3 to the time t4 are each one second in accordance with the command statement of G04 of the simulation program 81. However, since the time (time constant) until the target rotation speed of the spindle motor 8 is reached is not determined in advance, the speed estimation unit 14 calculates a change in the rotation speed of the spindle motor 8 in time series.

The speed estimation unit 14 calculates the angular acceleration of the spindle motor 8 during the period from the time t0 to the time t1. The speed estimation unit 14 calculates the output of the spindle motor 8 corresponding to the rotation speed, on the basis of the output characteristics of the spindle motor 8 shown in FIG. 5. As indicated by arrows 95 and 96, the speed estimation unit 14 calculates the output of the spindle motor 8 corresponding to a rotation speed of 2000 rpm. In this example, since the load factor for accelerating the spindle motor 8 is set to 100% by the first auxiliary variable, the output of the spindle motor 8 acquired in FIG. 5 can be adopted. When the load factor for acceleration of the spindle motor 8 is set to less than 100% by the first auxiliary variable, the output of the spindle motor 8 can be calculated on the basis of the output of the spindle motor 8 and the load factor for acceleration acquired in FIG. 5.

Next, the speed estimation unit 14 calculates the torque of the spindle motor 8 by dividing the output of the spindle motor 8 by the rotation speed. Then, the speed estimation unit 14 calculates an angular acceleration by dividing the torque of the spindle motor 8 by an inertia including the inertia of the rotor of the electric motor and the inertia of a load applied to the electric motor. The slope of the rotation speed from the time t0 to the time t1 in the graph corresponds to the angular acceleration. The speed estimation unit 14 can calculate a time length SX1 from the time t0 to the time t1 on the basis of a rotation speed and an angular acceleration that are finally reached. The speed estimation unit 14 can also calculate the time t1.

The speed estimation unit 14 can also calculate an angular acceleration during deceleration in the section from the time t2 to the time t3 by similar control. The speed estimation unit 14 can calculate a time length SX2 from the time t2 to the time t3. The speed estimation unit 14 can calculate the time t3 on the basis of the time t2 and the time length SX2. The calculation unit 13 can also estimate a time length (cycle time) during which the machine tool performs a task from the time t0 to the time t4, on the basis of the time lengths SX1 and SX2. In other words, the calculation unit 13 can calculate the time from the start to the stop of the electric motor according to the machining program.

In this way, the speed estimation unit 14 can estimate a change over time in the rotation speed on the basis of the angular acceleration. The speed estimation unit 14 can also calculate the time until the rotation speed of the spindle motor 8 reaches the target rotation speed, on the basis of the angular acceleration. The speed estimation unit 14 can also estimate a change over time in the rotation speed of the electric motor from the start to the stop of the electric motor.

In the first control, in order to calculate the rotation speed of the electric motor, it is possible to generate a command statement in which the first auxiliary variable is added as a load factor for acceleration of the electric motor to a command statement of the machining program. Then, an angular acceleration when the electric motor is accelerated or decelerated can be estimated on the basis of the output characteristics and inertia of the electric motor. It is also possible to generate a command statement in which the second auxiliary variable is added as a load factor corresponding to the cutting torque of the spindle motor to a command statement during the period in which the workpiece is being cut. With the second auxiliary variable, the load factor during the period of cutting the workpiece from the time t1 to the time t2 can be determined. The calculation unit 13 can estimate a change over time in the load factor of the electric motor from the start to the stop of the electric motor.

The second control of the estimation device 11 of the present embodiment is described below. In the second control, the drive state of the feed axis motor 5 is estimated. The time constant of the feed axis motor 5 is determined in advance. The time constant corresponds to an angular acceleration when the feed axis motor 5 is accelerated or decelerated. The time constant of the electric motor is defined in, for example, control software that controls the electric motor. In the second control, a torque output by the feed axis motor 5 when it is accelerated according to a constant angular acceleration is estimated. In the present embodiment, the load factor of the feed axis motor 5 is estimated. In the second control, a change over time in the rotation speed of the feed axis motor 5 and a change in the position of an object driven by the feed axis motor 5 are also estimated.

FIG. 7 shows a command statement described in a second simulation program in the second control. In a second simulation program 82, a command statement of G01 is described in order to drive the feed axis motor 5. The command statement of G01 of the second simulation program 82 is a command statement in which an auxiliary variable is described in the command statement of G01 of the machining program. The command statement of G01 indicates a command for linearly moving the table. The command statement indicates the movement in the X-axis direction of the table for fixing the workpiece.

In the machine tool 1 of the present embodiment, a machine coordinate system that is not moved even when the spindle head 6 and the table are moved is defined. In the command statement of G01, the target position of the table is indicated by the machine coordinate system. In the command statement of G01 is described a command for moving the table such that the coordinate value of the X-axis is 10 and the coordinate value of the Y-axis is 10 in the machine coordinate system. F1000 is a variable indicating a target movement speed when the table is moved. Here, it is described that the table is moved at a speed of 1000 mm/min.

In the second simulation program 82, a third auxiliary variable related to a load factor for machining the workpiece is added to the command statement of G01 used in the machining program. As the third auxiliary variable, “servocutpower10%” indicating the load factor of the feed axis motor 5 during cutting is added after the command statement of G01 in the machining program. This load factor corresponds to a torque command during cutting. The third auxiliary variable indicates that the load factor of the feed axis motor 5 when the workpiece is cut is 10%.

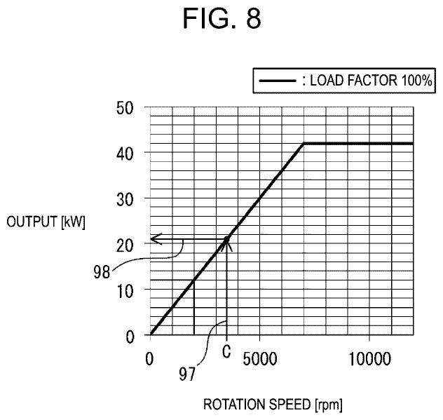

FIG. 8 is a graph showing output characteristics of the feed axis motor. Similarly to the graph of the spindle motor in FIG. 5, the graph of FIG. 8 shows the relationship between output and the rotation speed of the feed axis motor 5 at a load factor of 100%.

Referring to FIG. 2, the torque estimation unit 15 of the calculation unit 13 calculates a change over time in the load factor of the electric motor during operation on the basis of the time constant of the feed axis motor 5, the output characteristics of the feed axis motor 5, the command statement including the third auxiliary variable that is included in the simulation program 82, and the inertia related to driving of the electric motor. As will be described below, the torque estimation unit calculates a load factor when the feed axis motor is accelerated or decelerated.

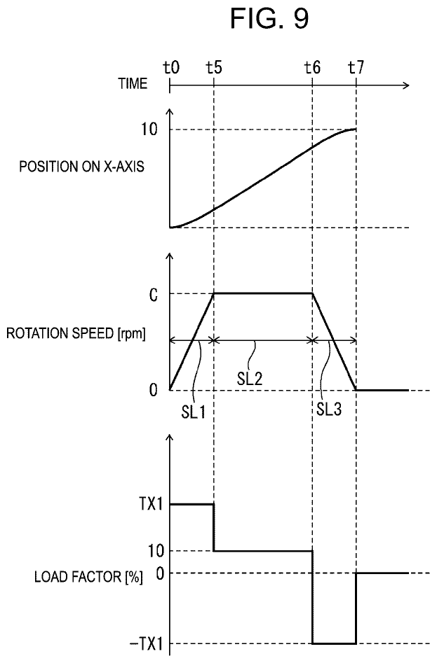

FIG. 9 illustrates a time chart of the drive state of the feed axis motor estimated by the second control. Here, an example is illustrated in which the table of the machine tool 1 is moved in the X-axis direction. From the time t0 to the time t5, the rotation speed of the feed axis motor increases. From the time t5 to the time t6, the rotation speed of the feed axis motor 5 is maintained at a constant rotation speed C. From the time t6 to the time t7, the rotation speed of the feed axis motor 5 decreases. The position of the table in the X-axis direction is moved from a current position to a position where the coordinate value of the X-axis is 10.

A target rotation speed C of the feed axis motor 5 when the table is moved in the X-axis direction can be calculated on the basis of the variable F1000 in the command statement of G01 in the simulation program 82. The variable F1000 indicates that the target movement speed of the table is 1000 mm/min. The calculation unit 13 can calculate the target rotation speed C of the X-axis feed axis motor 5 on the basis of the target movement speed of the table and the information 22 on the moving device such as the pitch of the ball screw of the ball screw mechanism that moves the table in the X-axis direction. Although an example is illustrated in which the table is moved in the X-axis direction, the present invention is not limited to this embodiment. When the table is moved in the Y-axis direction in addition to the X-axis direction, the rotation speed of the Y-axis feed axis motor can be calculated on the basis of the movement speed of the table in the Y-axis direction and the information on the moving device on the Y-axis. Also for the Y-axis feed axis motor, the drive state of the electric motor can also be estimated by control similar to that in the X-axis feed axis motor.

The calculation unit 13 calculates an angular acceleration from the time constant determined for the feed axis motor 5. The calculation unit 13 can calculate a change over time in the rotation speed in a section from the time t0 to the time t5. The calculation unit 13 can calculate a time length SL1 from the time t0 to the time t5 for reaching the target rotation speed C, on the basis of a change in the rotation speed. The calculation unit 13 can also calculate a change over time in the rotation speed and a time length SL3 in a section from the time t6 to the time t7 on the basis of the angular acceleration.

The calculation unit 13 can calculate the rotational position of the feed axis motor 5 at the time t5 and the time t6 by integrating the rotation speed of the feed axis motor 5. On the basis of the information 22 on the moving device, the calculation unit 13 can calculate the position on the X axis of the table corresponding to the rotational position of the feed axis motor 5. The calculation unit 13 can calculate the position of an object driven by the feed axis motor 5. The calculation unit 13 can calculate a movement distance in the X-axis direction from the time t5 to the time t6 on the basis of the rotational position of the feed axis motor 5 or the position of the table in the X-axis direction. Then, the calculation unit 13 can calculate a time length SL2 from the time t5 to the time t6 on the basis of the movement distance in the X-axis direction and the constant rotation speed C. The calculation unit 13 can estimate a time length (cycle time) during which the machine tool performs a task from the time t0 to the time t7. The calculation unit 13 can also calculate the times t5, t6, and t7 on the basis of the time lengths SL1, SL2, and SL3.

In this way, the calculation unit 13 can estimate a change in the rotation speed of the feed axis motor 5 and a change in the position of the table in the X-axis direction from the start to the end of the movement of the table. The calculation unit 13 can also estimate a time length from the start to the end of the movement of the table.

Then, in the second control, the torque estimation unit 15 of the calculation unit 13 calculates a change over time in the load factor of the feed axis motor 5 during operation. In the present embodiment, the torque estimation unit 15 calculates a load factor (TX1) when the feed axis motor is accelerated or decelerated.

Referring to FIGS. 8 and 9, in the section from the time t0 to the time t5, the torque estimation unit 15 calculates a torque required for acceleration by multiplying the inertia related to the driving of the electric motor by the angular acceleration. Referring to the output characteristics of the electric motor in FIG. 8, the torque estimation unit 15 calculates output when the load factor is 100%, on the basis of the target rotation speed C, as indicated by arrows 97 and 98. The torque estimation unit 15 calculates a torque when the load factor is 100% by dividing the output when the load factor is 100% by the rotation speed. The torque estimation unit 15 can calculate the load factor TX1 of the feed axis motor by dividing the torque required for acceleration by the torque when the load factor is 100%. The above load factor corresponds to a torque command of the feed axis motor 5 of the machine tool.

In this way, the torque estimation unit 15 calculates the load factor (TX1) in FIG. 9. A load factor (−TX1) during deceleration from the time t6 to the time t7 can also be calculated by similar control.

The load factor of the feed axis motor during the period in which the workpiece is machined by the machine tool 1 can be set in advance by the operator who performs a simulation. The operator can estimate a load factor during machining on the basis of information on the tool and information on the workpiece. Referring to FIG. 7, the operator specifies the load factor of the feed axis motor 5 during cutting as the third auxiliary variable in the second simulation program 82. In this example, the load factor of the feed axis motor 5 during cutting is 10%.

Referring to FIG. 9, the torque estimation unit 15 sets the load factor of the feed axis motor 5 during the period in which the workpiece is machined, on the basis of the third auxiliary variable described in the command statement of the simulation program 82. The torque estimation unit 15 sets the load factor of the feed axis motor 5 to 10% in the section from the time t5 to the time t6. As a result, the torque estimation unit 15 can estimate a change over time in the load factor from the start to the stop of the feed axis motor 5. In other words, it is possible to estimate a change in the load factor of the feed axis motor from the start to the end of the movement of the table. In this way, in the second control, the drive state of the feed axis motor 5 can be calculated.

When the torque estimation unit 15 calculates, in the second control, the torque required for acceleration, the torque required for acceleration may exceed the rated torque, i.e. the load factor may exceed 100%. When the variable estimated by the calculation unit 13 is out of a predetermined allowable range, the determination unit 16 of the calculation unit 13 performs control for notifying the operator who performs a simulation of the electric motor of this fact.

In the present embodiment, the determination unit 16 determines whether the load factor estimated by the torque estimation unit 15 is out of the allowable range. The allowable range of the load factor is determined in advance to be 0% or more and 100% or less. In particular, the determination unit 16 determines whether the load factor exceeds 100%. When the load factor exceeds 100%, the determination unit 16 can perform output of a text file including a warning indicating that the load factor is out of the allowable range, as control for notifying the operator of this fact. Alternatively, the determination unit 16 can put a warning into a file of the result of estimating the drive state of the electric motor.

On the other hand, the determination unit 16 may transmit, to the display control unit 17, a signal corresponding to information indicating that the load factor of the electric motor is out of the allowable range. The display control unit 17 can cause the display part 19 to display the fact that it is not possible to drive the machine tool under the current conditions. Alternatively, the display control unit 17 can cause the display part 19 to display the fact that the load factor of the feed axis motor 5 is out of the allowable range.

The control for notifying the operator who performs a simulation of the warning is not limited to the control for outputting a file including the warning or the control for displaying the information on the display part, and any control can be adopted. For example, voice may be used to notify the operator that it is not possible to drive the machine tool.

The estimation device of the present embodiment can estimate the drive state of the electric motor such as the rotation speed, the angular acceleration, and the load factor of the electric motor without actually driving the machine tool. On the basis of the estimated drive state of the electric motor, the operator who performs a simulation can confirm that there is no problem in driving the machine tool or can change conditions for driving the machine tool. Alternatively, the operator may make a change in a design of the machine tool such as a change in the type of the electric motor. The operator who operates the machine tool in order to machine the workpiece can also modify the machining program in accordance with the drive state of the electric motor estimated by the estimation device.

The estimation device of the present embodiment can estimate the drive state of the electric motor merely by adding the auxiliary variables to the machining program. Therefore, the operator who performs a simulation does not need to perform a complicated task for setting load conditions of the electric motor, and can easily perform the simulation.

The following is an example of controlling a plurality of electric motors in conjunction with each other. The first control described above is control of the electric motor in which the time constant corresponding to the angular acceleration is not determined, and the second control is control of the electric motor in which the time constant corresponding to the angular acceleration is determined. Even when the plurality of electric motors are controlled in conjunction with each other, at least one of the first control and the second control can be performed. Control for the machine tool to form a female screw in the workpiece is described below.

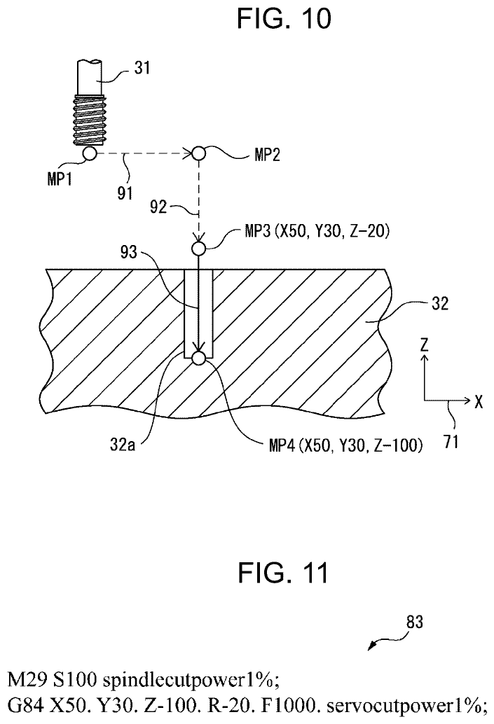

FIG. 10 illustrates a schematic partial cross-sectional view of a tool and a workpiece when a female screw is formed in the workpiece. A path of a tool 31 is described below by using a machine coordinate system 71. A tap is adopted as the tool 31. A workpiece 32 is provided with a hole 32a for forming a female screw on an inner peripheral surface thereof. The Z-axis feed axis motor 5 of the machine tool 1 moves the tool 31 in the direction of the Z-axis of the machine coordinate system 71. The X-axis feed axis motor 5 moves the table, on which the workpiece 32 is fixed, in the direction of the X-axis of the machine coordinate system 71. A path indicated by arrows 91, 92, and 93 is the path of the tool 31.

In this example, when the X-axis feed axis motor 5 is driven, a tool tip point of the tool 31 is moved from a movement point MP1 to a movement point MP2 in the direction of the X-axis of the machine coordinate system 71 as indicated by the arrow 91. When the Z-axis feed axis motor 5 is driven, the tool tip point is moved from the movement point MP2 to a movement point MP3 as indicated by the arrow 92. The tool 31 temporarily stops at the movement point MP3 close to the workpiece 32.

The coordinate values (x, y, z) of the movement point MP3 in the machine coordinate system 71 are (50, 30, −20). The coordinate values of a movement point MP4 in the machine coordinate system 71 are (50, 30, −100). As indicated by the arrow 93, when the tool tip point of the tool 31 is moved from the movement point MP3 to the movement point MP4, a female screw is formed on the circumferential surface of the hole 32a of the workpiece 32.

When the tool tip point is moved from the movement point MP3 to the movement point MP4, the drive state of one of the feed axis motor 5 for moving the tool 31 in the direction of the Z-axis and the spindle motor 8 for rotating the tool 31 is determined corresponding to the drive state of the other electric motor. Alternatively, the drive states of both the electric motors may be determined in advance. The operation control unit 4 of the machine controller 2 performs control such that the rotation speed of the tool 31 fixed to the spindle axis and the movement speed of the tool 31 with respect to the workpiece 32 (entering speed into the hole 32a) are synchronized when the female screw is formed. In other words, in accordance with the pitch of the female screw formed by the tool 31, the rotation speed of the spindle motor 8 and the rotation speed of the feed axis motor 5 are controlled so as to correspond to each other. Such machining in which the female screw is formed by the spindle motor and the feed axis motor synchronizing with each other is referred to as rigid tapping.

FIG. 11 shows a simulation program for forming the female screw. A third simulation program 83 shows control for movement from the movement point MP3 to the movement point MP4. A command statement of M29 indicates rigid tapping. A variable S100 indicates that the rotation speed of the spindle axis is 100 rpm. A command statement of G84 indicates a command for moving the tap when machining is performed by the tap. Coordinate values (50, 30, −100), which indicate a target movement point of the tool tip point, are specified. A variable R-20 indicates that a distance from the surface of the workpiece 32 to the movement point MP3 is 20 mm, and variable F1000 indicates that the feed speed of the tool is 1000 mm/min.

The command statement of M29 and the command statement of G84 are command statements used in the machining program of the machine tool, and are command statements for forming the female screw. In the simulation program 83, “spindlecutpower1%”, which is the second auxiliary variable indicating the load factor of the spindle motor 8 during cutting, is added to the command statement of M29 of the machining program. Further, “servocutpower1%”, which is the third auxiliary variable indicating the load factor of the feed axis motor 5 during cutting, is added to the command statement of G84 of the machining program. In accordance with such a simulation program 83, the drive state of the feed axis motor and the drive state of the spindle motor 8 when the female screw is formed are estimated.

For the rigid tapping, there are control in which the rotation of the spindle axis follows the movement of the tool in the Z-axis direction and control in which the movement of the tool in the Z-axis direction follows the rotation of the spindle axis. The control to be executed out of the two types of control is determined in advance. Alternatively, the two types of control may be selectable by the machining program or the like. First, as third control of the present embodiment, the control in which the rotation of the spindle axis follows the movement of the tool in the Z-axis direction is described.

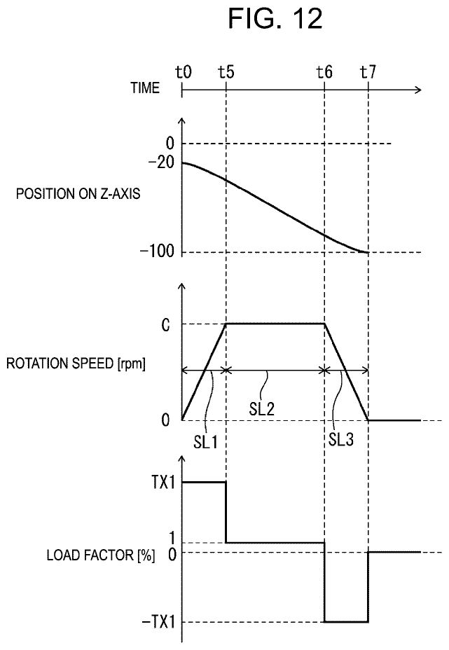

FIG. 12 is a time chart showing the drive state of the feed axis motor when rigid tapping in which the rotation of the spindle axis follows the movement of the tool is performed. Referring to FIGS. 11 and 12, the operation of the Z-axis feed axis motor 5 for moving the tool 31 is indicated by the command statement of G84. The control for estimating the drive state of the Z-axis feed axis motor 5 is similar to the second control described above. The target rotation speed C of the feed axis motor 5 is calculated from the variable F1000 indicating the feed speed of the tool 31, on the basis of the information 22 on the moving device such as the gear ratio of the reduction gear and the pitch of the ball screw.

Since the time constant of the Z-axis feed axis motor 5 is determined in advance, the calculation unit 13 calculates the time length SL1 at the time of acceleration, the time length SL2 at the rotation speed C, and the time length SL3 at the time of deceleration. The calculation unit 13 also calculates the position on the Z axis of the tool 31 by integrating the movement speed of the tool 31. As in the second control, the torque estimation unit 15 can calculate the load factor (TX1) at the time of acceleration and the load factor (−TX1) at the time of deceleration on the basis of the angular acceleration of the feed axis motor, the inertia, and the output characteristics of the motor.

The torque estimation unit 15 also sets the load factor of the feed axis motor 5 during cutting from the time t5 to the time t6, on the basis of “servocutpower1%”, which is the third auxiliary variable described in the command statement of G84 of the simulation program 83. The torque estimation unit 15 sets the load factor of the feed axis motor 5 during cutting to 1%.

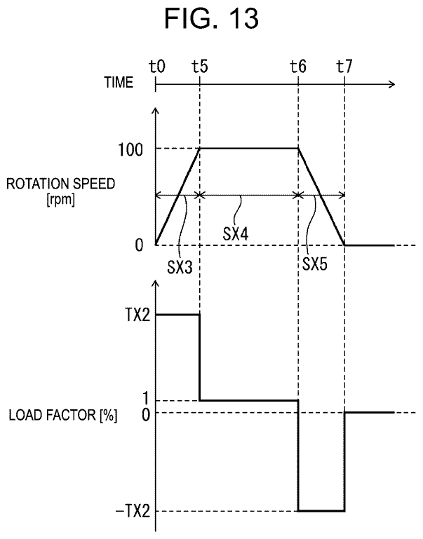

FIG. 13 is a time chart showing a drive state of the spindle motor when rigid tapping in which the rotation of the spindle axis follows the movement of the tool is performed. Referring to FIGS. 11 and 13, the operation of the spindle motor is specified by the command statement of M29 in the simulation program 83. The maximum rotation speed of the spindle motor 8 is 100 rpm on the basis of the variable S100.

The rotation speed of the spindle motor 8 corresponds to the movement speed of the tool 31. The calculation unit 13 calculates the rotation speed of the spindle motor 8 on the basis of the pitch of the female screw and the movement speed of the tool 31 corresponding to the rotation speed of the Z-axis feed axis motor 5. Alternatively, the calculation unit 13 calculates the angular acceleration of the spindle motor 8 on the basis of the angular acceleration of the Z-axis feed axis motor 5. A time length SX3 is the same as the time length SL1 in FIG. 12, a time length SX4 is the same as the time length SL2 in FIG. 12, and a time length SX5 is the same as the time length SL3 in FIG. 12.

The torque estimation unit 15 can calculate a load factor TX2 of the spindle motor 8 on the basis of the angular acceleration of the spindle motor 8 by the second control. The torque estimation unit 15 can also set the load factor of the spindle motor 8 during cutting from the time t5 to the time t6 to 1% from “spindlecutpower1%”, which is the second auxiliary variable added to the command statement of M29.

In the third control, it is possible to estimate the drive state of the feed axis motor and the drive state of the spindle motor when the rigid tapping is performed such that the rotation of the spindle axis follows the movement of the tool with respect to the workpiece. The determination unit 16 can determine the drive state of each motor.

As fourth control of the present embodiment, a control in which the movement of the tool in the Z-axis direction follows the rotation of the spindle axis is described below. In the control in which the movement of the tool in the Z-axis direction follows the rotation of the spindle axis, the spindle axis is accelerated with the maximum torque. In other words, the load factor of the spindle motor when the spindle axis is accelerated is 100%. Therefore, even though the first auxiliary variable related to the load factor when the rotation speed is increased is not described in the command statement of M29 in the simulation program 83 of FIG. 11, a load factor of 100% is adopted.

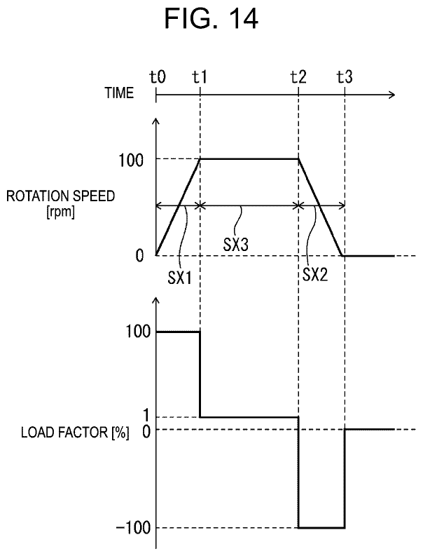

FIG. 14 is a time chart showing the drive state of the spindle motor when rigid tapping in which the movement of the tool in the Z-axis direction follows the rotation of the spindle axis is performed. Referring to FIGS. 11 and 14, the target rotation speed of the spindle motor 8 is specified by the variable S100 described in the command statement of M29. In this example, the target rotation speed of the spindle motor 8 is 100 rpm. The speed estimation unit 14 of the calculation unit 13 can calculate the angular acceleration of the spindle motor 8 by the first control. The speed estimation unit 14 can calculate the time lengths SX1, SX2, and SX3 and the times t1, t2, and t3. The load factor during cutting from the time t1 to the time t2 is set to 1% by “spindlecutpower1%”, which is the second auxiliary variable added to the command statement of M29.

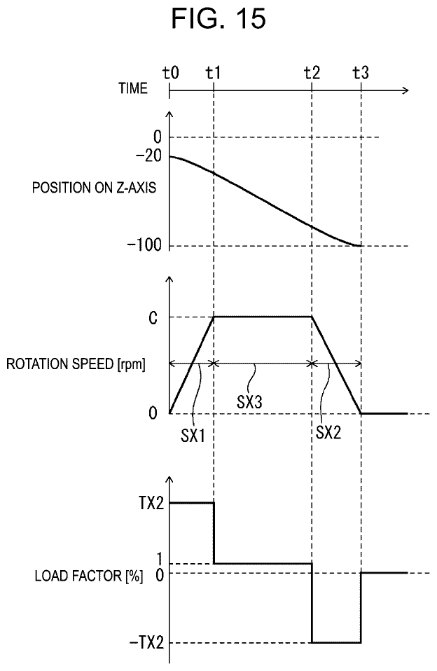

FIG. 15 is a time chart showing the drive state of the feed axis motor when the movement of the tool in the Z-axis direction follows the rotation of the spindle axis. The target rotation speed C of the feed axis motor is calculated on the basis of the variable F1000 of the movement speed of the tool specified in the command statement of G84 of the simulation program 83. The calculation unit 13 calculates the maximum rotation speed C on the basis of the information 22 on the moving device such as a movement speed of 1000 mm/min of the tool and the gear ratio of the reduction gear. As in the second control, the position on the Z axis can be calculated by integrating the movement speed of the tool 31. Then, as in the second control, the torque estimation unit 15 calculates the load factor TX2 when the feed axis motor is accelerated or decelerated. The load factor (cutting torque) of the feed axis motor for performing cutting during the period from the time t1 to the time t2 is set to 1% by “servocutpower1%” as the third auxiliary variable described in the command statement of G84.

In the fourth control, it is possible to estimate the drive state of the feed axis motor and the drive state of the spindle motor when rigid tapping is performed such that the movement of the tool with respect to the workpiece follows the rotation of the spindle axis. The determination unit 16 can determine the drive state of each electric motor.

Referring to FIG. 10, the movement point MP4 is a point at which the formation of the female screw is completed. The spindle motor 8 stops when the tool tip point of the tool 31 reaches the movement point MP4. Then, the spindle motor 8 rotates the tool 31 in an opposite rotation direction. The Z-axis feed axis motor 5 performs control for moving the tool 31 in a direction in which the tool 31 is removed from the hole 32a. Then, the tool 31 is moved until the tool tip point of the tool 31 reaches the movement point MP3. When the tool 31 is pulled out from the workpiece 32, the third control in which the rotation of the spindle axis follows the movement of the tool in the Z-axis direction or the fourth control in which the movement of the tool in the Z-axis direction follows the rotation of the spindle axis can also be performed.

Also in the third control and the fourth control, it is possible to estimate a change over time in the rotation speed from the start to the stop of the electric motor and a change over time in the load factor. With respect to the feed axis motor, the position of an object driven by the feed axis motor from the start to the stop can be estimated. The estimation device can calculate the time during which the machine tool performs machining. For example, in the third control illustrated in FIGS. 12 and 13, the time length from the time t0 to the time t7 is the time required for the tool tip point to move from the movement point MP3 to the movement point MP4. Even though the machine tool 1 is not actually driven, the calculation unit 13 can estimate the time during which the machine tool performs machining.

In a case where one electric motor is driven so as to follow the operation of another electric motor, when a torque of the one electric motor is calculated, the calculated torque may exceed a predetermined allowable value. For example, the load factor of the one electric motor may exceed 100%. Also in the third control and the fourth control, the determination unit 16 can determine whether the load factor calculated by the torque estimation unit 15 exceeds an allowable range. When the load factor calculated by the torque estimation unit 15 exceeds the allowable range, the determination unit 16 can perform control for notifying the operator who performs a simulation of this fact. Alternatively, when the rotation speed of one electric motor is calculated according to a change in the rotation speed of another electric motor, the one electric motor cannot follow the another electric motor in some cases. Even in such a case, the determination unit 16 can perform control for notifying the operator of a warning that the one electric motor cannot follow the another electric motor.

In the above-described embodiment, the Z-axis feed axis motor for moving the spindle head is described as an example of a feed axis motor; however, the present invention is not limited to this embodiment and any feed axis motor for moving any one of the tool and the workpiece can be adopted.

The above-described embodiments can be suitably combined. In each of the above drawings, the same or similar parts are denoted by the same reference numerals. It should be noted that the above-described embodiments are examples and do not limit the invention.

Further, the embodiments include modifications of the embodiments described in the claims.

### REFERENCE SIGNS LIST

1 Machine tool
5 Feed axis motor
6 Spindle head
7 Machining program
8 Spindle motor
11 Estimation device
13 Calculation unit
14 Speed estimation unit
15 Torque estimation unit
16 Determination unit
17 Display control unit
19 Display part
21, 81, 82, 83 Simulation program
23 Inertia information
24 Output characteristics of electric motor

1. An estimation device configured to estimate a drive state of an electric motor disposed in a machine tool, the estimation device comprising:
a calculation unit configured to calculate a variable indicating the drive state of the electric motor, in accordance with a simulation program created in advance, wherein
the electric motor is an electric motor in which time until a target rotation speed is reached when a rotational speed of the electric motor is changed is not determined,
the simulation program includes a command statement in which a first auxiliary variable related to a load factor for changing the rotation speed of the electric motor is added to a command statement of a machining program for driving the electric motor when a workpiece is machined, and
the calculation unit calculates a change over time in the rotation speed of the electric motor on the basis of an output characteristic of the electric motor, a predetermined inertia related to driving of the electric motor, and the first auxiliary variable.

2. The estimation device according to claim 1, wherein
the output characteristic of the electric motor corresponds to a relationship between output and the rotation speed when the electric motor is driven at a load factor of 100%, and
the calculation unit calculates the output of the electric motor corresponding to the target rotation speed on the basis of the output characteristic of the electric motor and the first auxiliary variable, calculates a torque of the electric motor by dividing the output of the electric motor by the rotation speed, calculates an angular acceleration of the electric motor by dividing the torque of the electric motor by the inertia, and calculates a change over time in the rotation speed on the basis of the angular acceleration.

3. The estimation device according to claim 1, wherein, on the basis of the change over time in the rotation speed, the calculation unit calculates time until the rotation speed of the electric motor reaches the target rotation speed.

4. The estimation device according to claim 1, wherein
the simulation program includes a command statement in which a second auxiliary variable related to a load factor for machining the workpiece is added to a command statement of the machining program for driving the electric motor, and
on the basis of the second auxiliary variable, the calculation unit estimates a change over time in the rotation speed of the electric motor and a change over time in the load factor of the electric motor from start to stop of the electric motor.

5. An estimation device configured to estimate a drive state of an electric motor disposed in a machine tool, the estimation device comprising:
a calculation unit configured to calculate a variable indicating the drive state of the electric motor, in accordance with a simulation program created in advance, wherein
the electric motor is an electric motor in which time until a target rotation speed is reached when a rotational speed of the electric motor is changed is determined,
the simulation program includes a command statement in which an auxiliary variable related to a load factor for machining a workpiece is added to a command statement of a machining program for driving the electric motor, and
the calculation unit calculates a change over time in the load factor of the electric motor on the basis of the time until the rotation speed of the electric motor reaches the target rotation speed, an output characteristic of the electric motor, a predetermined inertia related to driving of the electric motor, and the auxiliary variable.

6. The estimation device according to claim 5, wherein
the output characteristic of the electric motor corresponds to a relationship between output and the rotation speed when the electric motor is driven at a load factor of 100%, and
the calculation unit calculates an angular acceleration of the electric motor on the basis of the time until the rotation speed of the electric motor reaches the target rotation speed, calculates a torque required for acceleration on the basis of the angular acceleration and the inertia, calculates a torque when the load factor is 100% on the basis of the output characteristic and the target rotation speed, and calculates the load factor of the electric motor by dividing the torque required for acceleration by the torque when the load factor is 100%.

7. The estimation device according to claim 5, wherein the calculation unit calculates an angular acceleration of the electric motor on the basis of the time until the rotation speed of the electric motor reaches the target rotation speed, calculates a change over time in the rotation speed of the electric motor on the basis of the angular acceleration, and estimates a change in a position of an object driven by the electric motor, on the basis of the change over time in the rotation speed of the electric motor.

8. The estimation device according to claim 5, further comprising:
a determination unit configured to determine a variable estimated by the calculation unit, wherein
when the variable estimated by the calculation unit is out of an allowable range, the determination unit performs control for notifying an operator who performs a simulation of a fact that the variable is out of the allowable range.
